(19) United States
(12) Patent Application Publication
(10) Pub. No.: US 2025/0385500 A1
(43) Pub. Date: Dec. 18, 2025

(54) CABLE ENTRY PLATE

(71) Applicant: Dometic Sweden AB, Solna (SE)

(72) Inventor: Taylor Townsend, Victoria (CA)

(21) Appl. No.: 18/876,449

(22) PCT Filed: Jun. 15, 2023
(86) PCT No.: PCT/IB2023/056231

§ 371 Date: Dec. 18, 2024

Related U.S. Application Data
(60) Provisional application No. 63/353,712, filed on Jun. 20, 2022.

(51) Int. Cl. H02G 3/22; B60R 16/02; H02G 3/04; H02G 3/08; H02G 15/007; H02G 15/013

(52) U.S. Cl. CPC H02G 3/22; B60R 16/0222; H02G 3/0456; H02G 3/083; H02G 15/007; H02G 15/013

(57) ABSTRACT

Present embodiments relate to a cable entry plate. More specifically, but without limitation, present embodiments relate to a cable entry plate which locates wire and protects the wire while passing through a substrate such as a wall or roof material.

### PRIORITY/INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND

### 1. Field of the Invention

Present embodiments relate to a cable entry plate. More specifically, but without limitation, present embodiments relate to a cable entry plate which locates and protects one or more cables while passing through a substrate such as a wall, roof, or other substrate.

### 2. Description of the Related Art

Wires or cables are often required to pass through a substrate, such as a wall, roof, or substrate. Cables may be used on, for example of a recreational vehicle (RV) pass through the roof into the RV. This may be necessary, for example, for wires or conductors used to charge batteries in the RV from an exterior solar panel.

The wires can become damaged where they pass through the wall, roof, or substrate, due to rubbing on an edge of the wall, roof, or substrate through which the cable passes.

Additionally, where cables pass through a wall, roof, or substrate, it is desirable to inhibit water leakage therethrough.

It would be desirable to preclude such damage where the cables pass through. It would also be desirable to preclude water leakage through the location where the cables pass through the wall, roof, or substrate. It would be desirable to provide an improved structure for passing wires through a substrate.

The information included in this Background section of the specification. including any references cited herein and any description or discussion thereof, is included for technical reference purposes only and is not to be regarded as subject matter by which the scope of the invention is to be bound.

### SUMMARY

The present application discloses one or more of the features recited in the appended claims and/or the following features which alone or in any combination, may comprise patentable subject matter.

The present embodiments provide a cable entry plate with a space for receiving and turning one or more cables from an exterior location to an interior location. The cable entry plate provides a structure for protection of the one or more cables as they pass through a wall, roof, or other substrate. The structure also allows for securing of the one or more cables or wires so that the wires remain stationary and also do not rub on an adjacent edge of the wall, roof, or other substrate.

According to some embodiments a cable entry plate may comprise a planar structure having a cable aperture defined by an aperture boundary, a cowl disposed around the aperture boundary and extending from the planar structure, the cowl comprising an upright wall and at least one cover, a cable opening in the upright wall, the upright wall disposed adjacent at least a portion of the aperture boundary, the at least one cover extending from the upright wall to the planar structure and adjacent the aperture boundary, and, a guide depending from the at least one cover and to an elevation below the planar structure, the guide formed integrally with the at least one cover.

In some optional embodiments, the guide may have a first segment and a second segment. The first segment and the second segment may define a location wherein a cable may be disposed. The first segment and the second segment forming a trough. The guide may have three segments. The guide may have one of a v-shaped, u-shaped, or circular cross-section. The guide depending vertically from the cowl. The wire opening may have line of sight alignment with the guide. The cable entry plate may further comprise a retaining structure disposed on the guide to retain a cable against the guide. The cable opening may be two cable openings. The aperture may be free of structure along said aperture boundary. The guide may being centered relative to the cable aperture.

According to some embodiments, a cable entry plate may comprise a planar structure having an aperture therein defined by an aperture boundary, a cowl comprising an upright wall and at least one cover, the upright wall extending from the planar structure, a cable opening in the upright wall, a guide disposed opposite the cable opening, the at least one cover extending from the upright wall to the planar structure, the at least one cover being curved, the guide depending from the at least one cover to an elevation below the at least one cover.

In some optional embodiments, the guide may be disposed in line of sight relationship from the cable opening. The cable opening disposed in a rear facing surface of the cowl. The guide may be capable of protecting a cable where the cable passes through a surface of a vehicle. The guide may be one of U-shaped, V-shaped, or circular in cross-section. The guide may define a trough wherein one or more cables may be disposed. The guide configured to partially or fully enclose a wire or a cable.

According to some embodiments, a method of installing a cable entry plate may comprise connecting connectors to the cable entry plate, attaching the cable entry plate to a vehicle, attaching cables to a guide within the cable entry plate, and, connecting the cables to the connectors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present disclosure is provided in the following written description of various embodiments of the invention, illustrated in the accompanying drawings, and defined in the appended claims.

### BRIEF DESCRIPTION OF THE DRAWINGS

In order that the embodiments may be better understood, embodiments of a cable entry plate will now be described by way of examples. These embodiments are not to limit the scope of the claims as other embodiments of a cable entry plate will become apparent to one having ordinary skill in the art upon reading the instant description. Non-limiting examples of the present embodiments are shown in figures wherein:

FIG. 1 is a side-section view of a portion of a recreational vehicle with the cable entry plate disposed adjacent to a solar panel according to one or more embodiments;

FIG. 2 is a perspective view of a cable entry plate according to one or more embodiments;

FIG. 3 is a lower perspective view showing two cables within a space of the cable entry plate according to one or more embodiments;

FIG. 4 is a further lower perspective view revealing more of a guide within the space of FIG. 2 according to one or more embodiments;

FIG. 5 is a section perspective view of the cable entry plate according to one or more embodiments; and,

FIGS. 6-9 are views of various alternate embodiments which show alternate guides according to one or more embodiments.

### DETAILED DESCRIPTION

It is to be understood that a cable entry plate is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

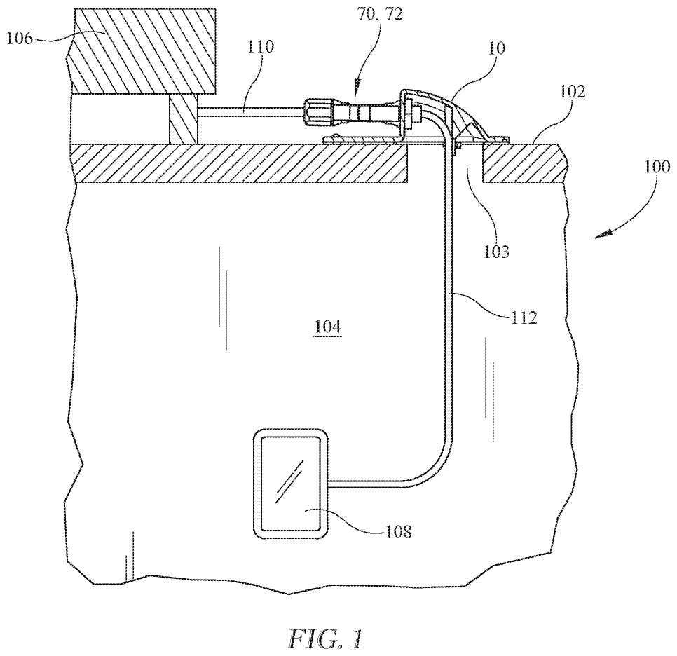

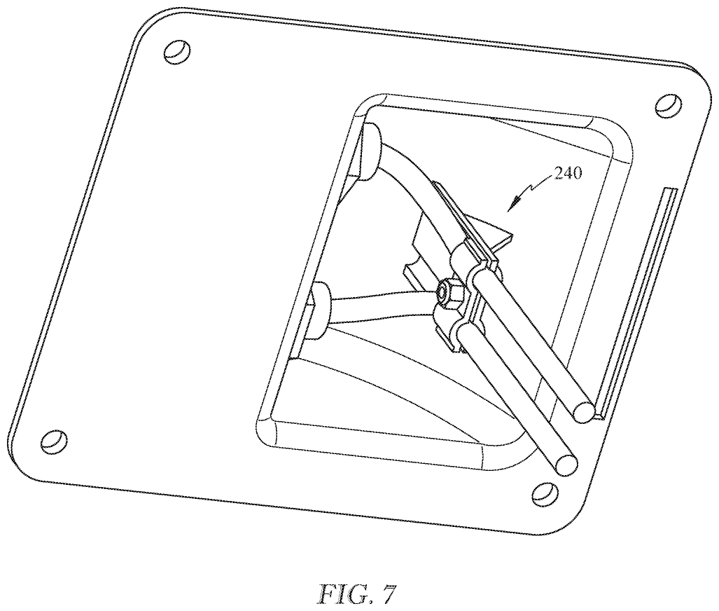

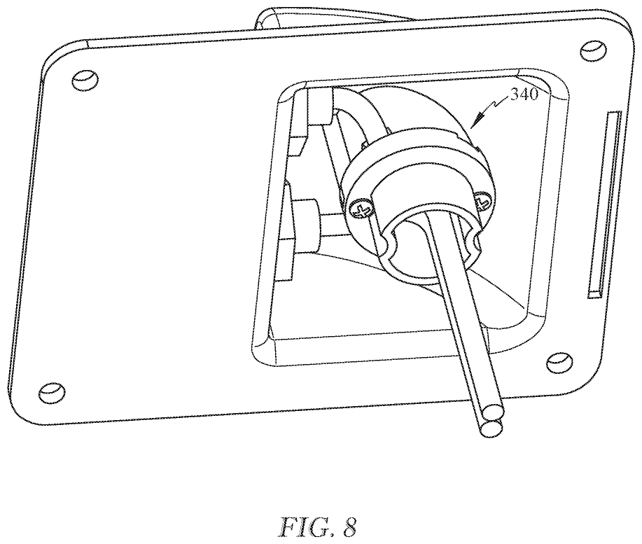

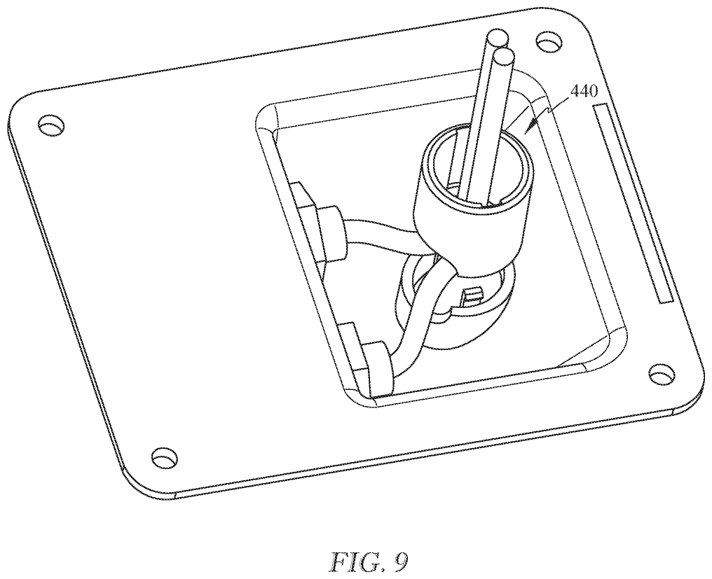

Referring to FIGS. 1-9, the present embodiments relate to a cable entry plate provides a structure for moving cables through a wall, roof, or substrate. The structure allows cables to enter the cable entry plate and turn through the wall, roof, or substrate. A hole for cable passage may be located in the wall, roof, or substrate and beneath or adjacent to the cable entry plate. Additionally, the cable entry plate may locate and guide the cable through the hole and further preclude damage from wire or cable rubbing on the edge of the hole.

Referring now to FIG. 1, a side-section view of the cable entry plate disposed on a recreational vehicle 100 for passage is shown. The recreational vehicle (RV) 100 is depicted having a roof 102 which is shown cross-hatched and a wall 104, which may be an interior wall or an exterior wall. On the roof 102, also shown in cross-hatch, is a solar panel 106. The solar panel 106, or photovoltaic panel, is a panel which receives sunlight and converts such to electrical energy for storage in a battery (not shown) or other capacitor. The solar charging system may comprise a controller 108 located on the wall of the RV 100. While a single solar panel 106 is shown, the solar panel 106 may be one or more solar panels.

The solar panel 106 includes one or more cables 110 extending from the one or more panel 106 which typically are in electrical communication with the solar controller 108 that communicates with at least one vehicle electrical system, or the solar charging system, or both. The controller 108 may display charging status or other system information for the user, as well as allowing the user to provide input for operational settings.

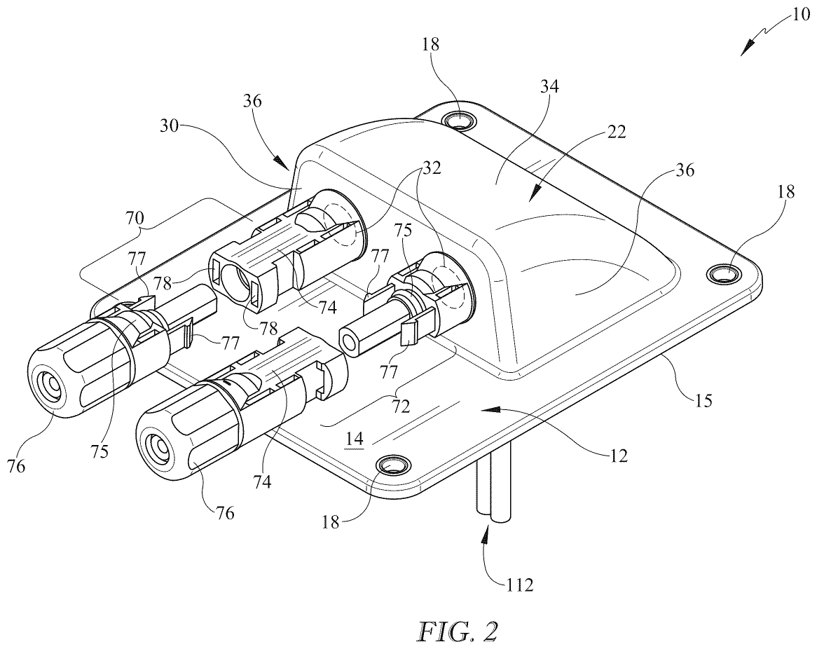

With the one or more cables or wires 110 extending from the solar panel 106 and extending to the controller 108, the cables 110 must pass through the roof 102. A hole 103 is formed in the roof 102 wherein the one or more cables 110 may pass through the roof 102 from the exterior to the interior. A cable entry plate 10 is provided which covers the hole 103. The cable entry plate 10 allows the one or more cables 110 to pass through a wall, roof, or other substrate of the RV 100. The cable entry plate 10 either allows passage of the cables 110 from the one or more solar panels 106 or may comprise connectors 70, 72 (FIG. 2) that allow external-to-internal cable communication via the cable entry plate 10. In the instant embodiment, the cables or wires 110 from the solar panel 106 are connected via the connectors 70, 72 at the cable entry plate 10 to cable passing downwardly from the cable entry plate 10 through the wall, roof, or substrate. The cable entry plate 10 provides a cover for the hole 103 in the roof 102, and additionally guides and protects the one or more cables 110 moving through the wall, roof, or other substrate. Once the cables pass through the wall, roof, or substrate, the cables 110 extend to the solar controller 108 for example through a wall or other structure to a location for connection.

Additionally, the terms cable(s) and wire(s) are used herein and either may be utilized with the entry plate 10. The term wire generally refers to single core conductor in a jacket while the term cable generally refers to two or more conductors in a jacket. While the embodiments are referred to as cable entry, the term cable should be considered inclusive of a single conductor wire and should be considered within the scope of this teaching and claims.

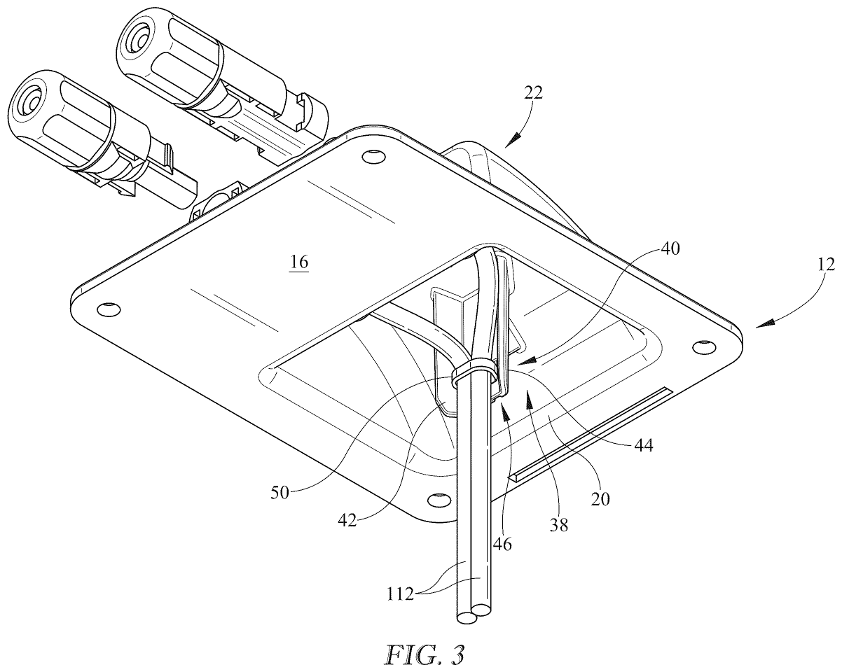

Referring to FIG. 2, a perspective view of the cable entry plate 10 is shown. The cable entry plate 10 comprises a planar structure 12 which is shown in rectangular form. The planar structure 12 has an upper surface 14 and a lower surface 16 (FIG. 3). The planar structure 12 is shown rectangular but may be square or may be other shapes. The size and the shape may vary and may depend on the size of the hole, the number of cables passing through the cable entry plate 10, and the size and shape of the hole in wall, roof, or substrate.

The planar structure 12 may include one or more fastening apertures 18 through which fasteners may pass to connect the planar structure 12 to the wall, roof, or substrate. Additionally, or alternatively to the screws, an adhesive can be used between the underside of the planar structure 12 and the roof 102. There is sufficient surface area to allow this. In either embodiment, a sealant may additionally be required on the lower surface 16 around the edge 15. For example, a sealant such as silicone or other type adhesive may be used on the bottom surface 16 and/or around a peripheral edge 15 of the planar structure 12. The sealant may be used to inhibit water entry between the planar structure 12 and the wall, roof, or other substrate.

The planar structure 12 may further comprise a central aperture 20 (FIG. 3) that is hidden in this view. The central aperture 20 allows the cable to pass through the planar structure 12 and through the wall, roof, or substrate below. The central aperture 20 is merely central between two opposed edges and need not be completely centered on the planar structure 12. Moreover, the term “central” is merely descriptive and thus, should not be considered limiting as the aperture 20 need not be centered between any edges of the planar structure 12.

The central aperture 20 is hidden by a cowl 22 which extends from the planar structure 12. The cowl 22 hides and protects the wire from an exterior location and provides space for the wire to turn and move downward through the aperture 20. The cowl 22 is defined by an upright wall 30 and at least one cover 34. Extending from the upper surface of the planar structure 12 is an upright wall 30. The upright wall 30 is disposed near the central aperture 20. The upright wall 30 may be a single planar structure or comprised of two or more segments. The upright wall 30 may be vertical, angled, or may be curved. The upright wall 30 comprises at least one cable aperture or opening 32 through which at least one cable passes. In some embodiments, the at least one aperture 32 may comprise multiple apertures. In the depicted example, there are two cable apertures 32 for two cables. The aperture 32 may be sized for individual cables, or may be sized to fit multiple cables through a single aperture. The aperture 20 may be defined by a boundary formed in the planar structure 12.

The cowl 22 further comprises at least one cover 34 which extends from the upright wall 30 down to the planar structure 12. The at least one cover 34 may be curved or linear and may comprise one or more surfaces. In the instant embodiment, the at least one cover 34 comprises two sidewalls 36 that depend from the at least one cover 34 to the planar structure 12. The sidewalls 36 and cover 34 surround the central aperture 20 and provide protection to the one or more cables passing through aperture 32 and turning downward to pass through the central aperture 20.

The upright wall 30 and the cover 34 provide a location where one or more cables or wires 110 (FIG. 1) may enter a space 38 (FIG. 3) beneath the cover 34 and turn downwardly through the central aperture 20 in the planar structure 12.

Also shown in FIG. 2 are the connectors 70, 72. In some embodiments, the connectors 70, 72 may be solar connectors, for example MC4 connectors, which are single contact electrical connectors and are suitable for solar panel connectivity. The connectors 70, 72 generally utilize push pin connectors to provide an electrical connection of first wires or cables 110 from the solar panel 106 and a second wire or cables 112 extending through the roof 102 or wall 104 (FIG. 1). In the solar panel configuration, there is typically a positive conductor wire or cable and a negative conductor wire or cable for each of the wires or cables 110, 112. The connectors 70, 72 each comprise a male portion and a female portion defined by pins that are located within the connectors 70, 72. The pins are crimped or soldered to the conductors of the wires or cables 110, 112. Each of the connectors 70, 72 is formed of a coupler body 74, 75 which provide a sealed connection to the wire or cable 110, 112. Each coupler body 74, 75 on the exterior of the cable entry plate 10 may comprise an end cap 76 which threads to the coupler body 74, 75 and retains the wire or cable 110 in position. An interior strain relief may also be provided within the connectors 70, 72. Additionally, the one of the coupler bodies 74, 75 may include fingers 77 which engage holes 78 to lock the pair of coupler bodies together. While the connectors 70, 72 are depicted as solar connectors, other terminal types may be utilized, or other water resistant connections may be utilized to allow passage of wires, or the connections to provide electrical connectivity. Still further, the wire or cables 110 may pass through the plate 10 from exterior to interior, as opposed to two wires or cables 110, 112 and a connector.

Referring now to FIG. 3, a lower perspective view of the cable entry plate 10 is shown. In this view, the lower surface 16 of the planar structure 12 reveals the central aperture 20 beneath the cowl 22. The central aperture 20 may be centrally located between two edges of the planar structure 12. However, the central aperture 20 need not be centrally located between of the one or more peripheral edges 15. The aperture 20 is defined by a peripheral boundary which may be located at any location in the planar structure 12.

A space or opening 38 inside the cowl 22 and beneath the cover 34 is also shown in the depicted view. The space 38 provides a location for the one or more cables to enter and turn to move downward through the wall, roof, or substrate. Space 38 may be sized to allow for the desired number of cables to fit and turn without crimping or otherwise damaging the cables.

Inside the cowl 22 is a guide 40. For example, in the instant example, the guide 40 is shown depending from the bottom of the cover 34. The guide 40 is intended to be aligned with a hole in the wall, roof or substrate beneath the cable entry plate 10, and additionally provides a protective function. The guide 40 is also in line-of-sight alignment with the at least one aperture 32 (FIG. 2). Additionally, the guide 40 may be centered relative to the aperture 20 in the planar structure 12 so that the guide 40 controls the wiring movement through a vehicle wall or roof. The guide 40 may be formed integrally to the cover 34, or may be formed separately and connected, for example by fastener adhesive, or the like.

The guide 40 has a length that extends downward from the cover 34 and below the bottom surface 16 of the cable entry plate 10. The guide 40 may extend past the outer surface of the wall, roof, or other substrate, or may extend through both the outer and the inner surface. In the instant embodiment of FIG. 1, for non-limiting example, the guide 40 extends past the outer, upper surface but not the inner surface of the roof 102, wall, or like. In some embodiments, the guide 40 depends downwardly in a vertical orientation. With the guide 40 extending below lower surface 16 of the cable entry plate 10, the guide 40 will extend through a hole in the wall, roof, or other substrate and the one or more cables 112 are protected on at least one side from an edge of the hole in the wall, roof, or substrate.

The guide 40 may be centrally located relative to the aperture 20. This locates the wires 112 in a central location relative to the opening 103 (FIG. 1) in the wall, roof, or substrate. This therefore positions the wires 112 away from edges in the opening 103 (FIG. 1). Additionally, the guide 40 may extend through the opening 103 and either partially or completely surround the wires 112 so that the wires 112 cannot be damaged by for example the edge of the opening 103.

The guide 40 may be formed of various shapes. For example, the guide 40 is shown as generally U shaped and formed of three segments 42, 44, 46 that extend downwardly. However, the guide 40 may also be V-shaped and for example formed of two segments defining the V-shape. Still further, the guide 40 may be formed of a single curved segment. The guide 40 is open toward the at least one aperture 32 of the upright wall 30, so that the one or more cables passing through the apertures 32 of the upright wall 30 may be positioned against or adjacent to the guide 40. In these embodiments, the guide 40 defines a trough where the at least one cable may be located as it turns and extends through wall, roof, or other substrate.

In some embodiments, the guide 40 may also be fully enclosed with a upper open area, so that the at least one cable may enter the guide 40 but is protected on all sides as the guide 40 moves through the wall, roof, or substrate. Additionally, the guide 40 may be formed integrally with the cover 34, as shown, or may be formed separately and added by fastener, connector, adhesive, or other such material for joining. In some embodiments, the cable entry plate 10 may be molded piece to which wiring connectors are added.

Where an open sided guide 40 is used, the one or more cables may be attached or otherwise retained to the guide 40. A strap, clamp, or other retaining structure 50 may be utilized to retain the wire in position and provide a strain relief function. With the one or more cables retained against the guide 40, the one or more cables are stabilized from moving away from the guide 40 and rubbing the hole in the wall, roof, or substrate on one side, and further disposed in the guide 40 so that the wires are protected from rubbing the hole on the opposite side. Additionally, the strap, clamp, or other retaining structure 50 provides a strain relief function. The retaining structure 50 retains the wires 112 and protects from stress tension, and therefore reduces the risk of connection failure. In some embodiments, the retaining structure 50 may be a zip-tie device, however other mechanical fastening, snap joints, adhesive, or ultrasonically welding may be used to connect the wires 112 to the guide 40.

Since the guide 40 extends downward below the bottom surface 16 of the cable entry plate 10, the one or more cables are protected by the guide 40 until the one or more cables pass by the edge of the wall, roof, or substrate. Further, while the slide 40 is shown depending vertically, it may also be angled or curved.

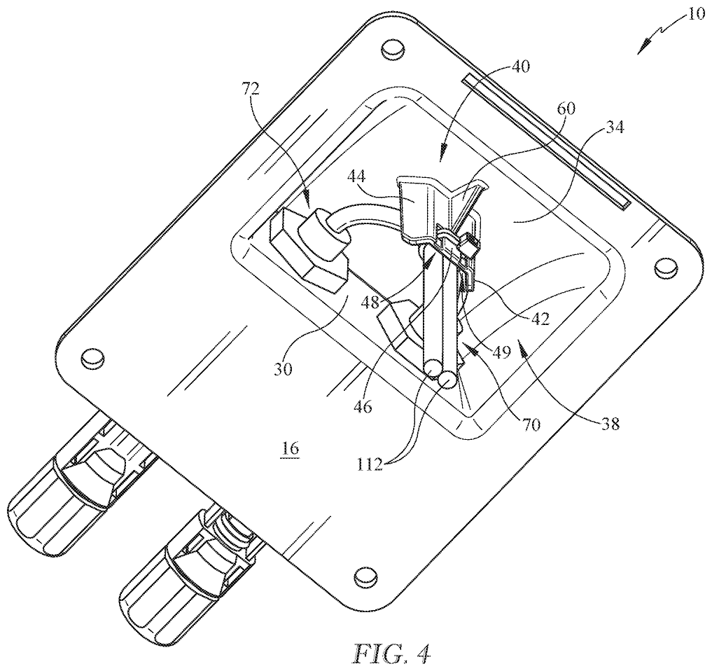

Referring now to FIG. 4, a lower perspective view of the cable entry plate 10 is shown. The lower perspective view shows the opening 38 in the planar structure 12 and provides an alternate view of the guide 40. The guide 40 is shown with the three segments 42, 44, 46 as previously described. The three segments 42, 44, 46 comprise a middle segment 46 having first and second slots 48, 49. The slots 48, 49 allow for passage of the strap, clamp, or other retaining structure 50. In some embodiments, the retaining structure 50 may be for non-limiting example, a zip-tie. The slots 48, 49 allow space for positioning of the zip tie 50, which retains the one or more cables closer to the guide 40.

The guide 40 and retaining of the one or more cables provides an additional advantage. The protection of the one or more cables allows use of indoor cables, rather than needing the more expensive exterior cables with thicker or heavier shielding material thus reducing cost of manufacturing or installation.

Still further, a web 60 is disposed against the guide 40 and engages the cover 34. The web 60 provides some rigidity for the guide 40 so that forces from the one or more cables do not bend or break the guide 40.

Also shown in this figure, the connectors 70, 72 extend through apertures 32 in the upright wall 30. The connectors 70, 72 may be fastened by a nut to snug the connectors against the upright wall 30.

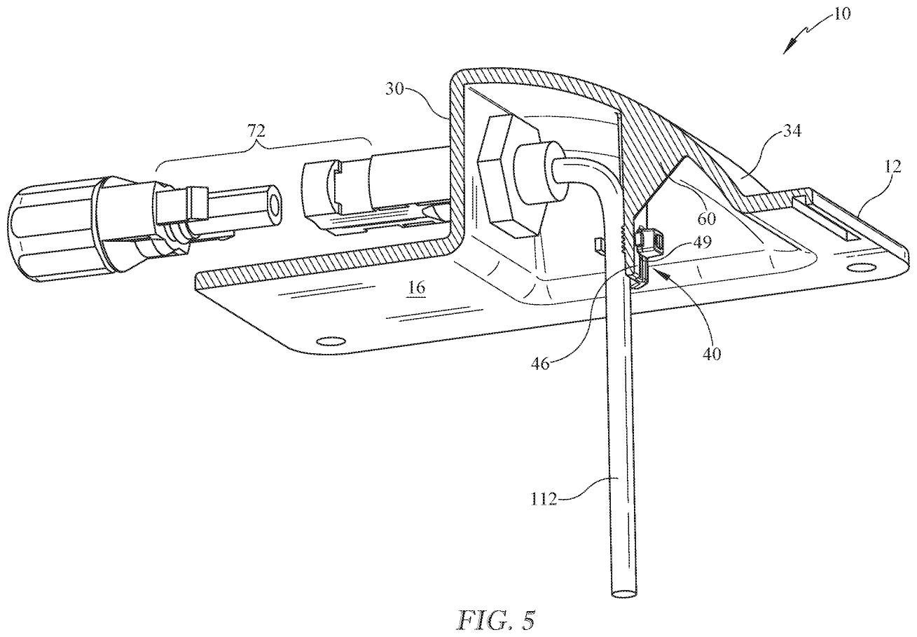

Referring now to FIG. 5, a section side perspective view is shown. In the side section view, the web 60 is more clearly shown connected to the guide 40. More specifically, the guide 40 depends from the cover 34 and engages the middle segment 46. The guide 40 is disposed between the slots 48, 49 one of which is shown in the section view.

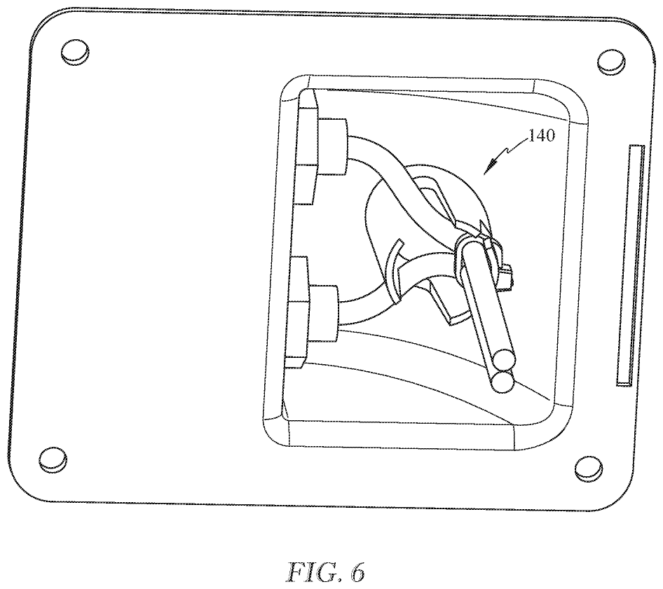

Referring now to FIGS. 6-9, various lower views are shown of alternate embodiments of guides. For example, guide 140 is shown being generally circular to allow the wires to be completely enclosed and therefore provide further shape alternative for the guide. The guide 140 may include cut-outs or slots to allow passage of wires therein. The wire guide 140 is also shown molded with the cover of the cowl.

A further guide 240 is also shown depending from the cover but includes a screw-clamp to retain the wires to the guide 240. This merely provides an alternate means of connecting the wires to the guide 240.

A third guide 340 is shown having a circular cross-section and formed of two pieces. An upper portion is molded to the cover and a second, lower portion is fastened to the upper portion. The enclosed guide provides a further embodiment means of retaining and protecting the wires. Whereas the previous fastening clamp functions horizontally, the instant guide 340 uses vertically oriented fasteners.

The fourth guide 440 is shown exploded apart and provides a snap-fit connection. This guide 440 is a two piece structure and includes a slot or opening for entry of the wires. The guide 440 has a hollow interior through which the wires passes.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A cable entry plate comprising:
a planar structure having a cable aperture defined by an aperture boundary;
a cowl disposed around the aperture boundary and extending from the planar structure;
said cowl comprising an upright wall and at least one cover, said upright wall disposed adjacent at least a portion of said aperture boundary;
said at least one cover extending from said upright wall to said planar structure and adjacent said aperture boundary, a cable opening in said upright wall; and.
a guide depending from said at least one cover and to an elevation below said planar structure, said guide formed integrally with said at least one cover.

2. The cable entry plate of claim 1. said guide having a first segment and a second segment.

3. The cable entry plate of claim 2, said first segment and said second segment defining a location wherein a cable may be disposed.

4. The cable entry plate of claim 2, said first segment and said second segment forming a trough.

5. The cable entry plate of claim 1, said guide having three segments.

6. The cable entry plate of claim 1, said guide having one of a v-shaped, u-shaped, or circular cross section.

7. The cable entry plate of claim 6, said guide depending vertically from said cowl.

8. The cable entry plate of claim 1, said guide being a one piece or multi-piece structure.

9. The cable entry plate of claim 1, further comprising a retaining structure disposed on said guide to retain a cable against said guide.

10. The cable entry plate of claim 1, said cable opening being two openings.

11. The cable entry plate of claim 1, said aperture being free of structure along said aperture boundary.

12. The cable entry plate of claim 1, said guide being centered relative to the cable aperture.

13. A cable entry plate, comprising:
a planar structure having an aperture therein defined by an aperture boundary;
a cowl comprising an upright wall and at least one cover, said upright wall extending from said planar structure;
a cable opening in said upright wall;
a guide disposed opposite said cable opening;
said at least one cover extending from said upright wall to said planar structure, said at least one cover being curved;
said guide depending from said at least one cover to an elevation below said at least one cover.

14. The cable entry plate of claim 13, said guide disposed in line of sight relationship from said cable opening.

15. The cable entry plate of claim 13, said cable opening disposed in a rear facing surface of said cowl.

16. The cable entry plate of claim 13, said guide capable of protecting a cable where said cable passes through a surface of a vehicle.

17. The cable entry plate of claim 13, said guide being one of U-shaped, V-shaped, or circular in cross-section.

18. The cable entry plate of claim 13, said guide defining a trough wherein one or more cables may be disposed.

19. The cable entry plate of claim 13, said guide configured to partially or fully enclose a wire or a cable.

20. A method of installing a cable entry plate, comprising:
connecting connectors to the cable entry plate;
attaching said cable entry plate to a vehicle;
attaching cables to a guide within said cable entry plate; and, connecting said cables to said connectors.
